(19) United States
(12) Patent Application Publication
(10) Pub. No.: US 2016/0028051 A1
(43) Pub. Date: Jan. 28, 2016

(54) POUCH-TYPE SECONDARY BATTERY FOR PREVENTING WATER PERMEATION

(71) Applicant: LG Chem, Ltd., Seoul (KR)

(72) Inventor: Du-Seong Yoon, Daejeon (KR)

(73) Assignee: LG Chem, Ltd., Seoul (KR)

(21) Appl. No.: 14/432,037

(22) PCT Filed: Oct. 31, 2014
(86) PCT No.: PCT/KR2014/010395

§ 371 Date: Mar. 27, 2015

(30) Foreign Application Priority Data
Nov. 1, 2013 (KR) 10-2013-0132440
Oct. 31, 2014 (KR) 10-2014-0150287

(51) Int. Cl. H01M 2/08; H01M 10/0525; H01M 2/02

(52) U.S. Cl. CPC H01M 2/08; H01M 2/0202; H01M 2/0237; H01M 10/0525; H01M 2220/30; H01M 2220/20

(57) ABSTRACT

Disclosed is a pouch-type secondary battery. The pouch-type secondary battery according to the present disclosure includes an electrode assembly comprising a cathode plate and an anode plate and a separator interposed between the cathode plate and the anode plate; and a pouch-type case formed by receiving and packaging the electrode assembly and an electrolyte solution inside, the pouch-type case having a sealing part formed along a circumference thereof, wherein a water permeation prevention member is attached to the entire sealing part formed along the circumference of the pouch-type case by welding.

### TECHNICAL FIELD

The present disclosure relates to a secondary battery, and more particularly, to a pouch-type secondary battery for preventing water permeation.

The present application claims priority to Korean Patent Application No. 10-2013-0132440 filed in the Republic of Korea on Nov. 1, 2013 and Korean Patent Application No. 10-2014-0150287 filed in the Republic of Korea on Oct. 31, 2014, the disclosures of which are incorporated herein by reference.

### BACKGROUND ART

Generally, as opposed to a disposable primary battery, a secondary battery is rechargeable and has a wide range of applications, for example, electronic devices including mobile phones, laptop computers, and camcorders, or electric vehicles. In particular, a lithium secondary battery has an operating voltage higher than or equal to 3.6V and has a capacity about three times larger than a nickel-cadmium battery or a nickel-hydrogen battery being widely used as a power source of electronic devices, as well as a high energy density per unit weight, and thus its use is on a rapid upward trend.

A lithium secondary battery primarily uses lithium-based oxide and a carbon material as a cathode active material and an anode active material, respectively. The lithium secondary battery includes an electrode assembly including a cathode plate and an anode plate respectively coated with the cathode active material and the anode active material with a separator interposed between the cathode plate and the anode plate, and an outer casing, hereinafter referred to as a battery case, designed to hermetically receive the electrode assembly and an electrolyte solution together.

Based on the shape of the battery case, the lithium secondary battery may be classified into a can-type secondary battery in which an electrode assembly is embedded in a metal can and a pouch-type secondary battery in which an electrode assembly is embedded in a pouch of an aluminum laminate sheet.

FIG. 1 is a diagram schematically illustrating a construction of a pouch-type secondary battery according to a related art.

Referring to FIG. 1, the pouch-type secondary battery includes a case, an electrode assembly, an electrode tab, an electrode lead, and a sealing part.

The case 11 includes an upper pouch case and a lower pouch case, and may be formed with a sufficient size to accommodate the electrode assembly 12, the electrode tab 13, and the electrode lead 14, and on an outer side, the case 11 includes the sealing part 16 formed by heat fusion of the upper case and the lower case.

The electrode assembly 12 includes a cathode plate, an anode plate, and a separator. The electrode assembly 12 may have the cathode plate and the anode plate stacked in a sequential order with the separator interposed between the cathode plate and the anode plate. The electrode assembly 12 typically includes, for example, a jelly-roll (wound) electrode assembly having a structure in which long sheet-type cathodes and anodes are wound with separators interposed therebetween, a stack-type electrode assembly having a structure in which a plurality of cathodes and anodes cut to a predetermined size are stacked in a sequential order with separators interposed therebetween, and a stack/folding-type electrode assembly having a structure in which bicells or full cells including a predetermined unit of cathodes and anodes stacked with separators interposed therebetween are folded.

The electrode tab 13 extends from the electrode assembly 12. For example, a cathode tab extends from the cathode plate, and an anode tab extends from the anode plate.

Here, when the electrode assembly 12 includes a plurality of cathode plates and a plurality of anode plates stacked on top of each other, the electrode tab 13 extends from each of the cathode plates and each of the anode plates. In this instance, the electrode tab 13 may be connected to the other component such as the electrode lead 14 while not being directly exposed to the outside of the case 11.

The electrode lead 14 is electrically connected, in part, to the electrode tabs 13 extending respectively from the cathode plate or the anode plate. That is, a cathode lead is coupled and electrically connected to the cathode tab, and an anode lead is coupled and electrically connected to the anode tab. Also, an insulation film 15 may be attached to a portion of upper/lower surfaces of the electrode lead 14 to increase the sealing with the battery case 11, and at the same time, to ensure the electrical insulation.

To manufacture the pouch-type secondary battery according to the related art as described above, an electrode assembly is put in a pouch-type case and an electrolyte solution is then injected, followed by a post-treatment process such as a sealing process, an aging process, and a chemical conversion coating process, and thereby a complete secondary battery is provided.

The sealing part 16 may be formed along an outer circumference of the case by joining or adhering the upper case and the lower case by heat fusion in the sealing process of the pouch-type case, and preferably, the sealing part 16 represents a strip of a heat fusion layer formed at a contact area of the upper case and the lower case by the heat fusion.

FIG. 2 is a diagram illustrating a process of forming the sealing part of the pouch-type case of FIG. 1, as viewed in cross section.

Referring to FIG. 2, a laminate sheet 20 includes an outer resin layer 20a comprising an outermost part, a shielding metal layer 20b to prevent the penetration of a material, and an inner resin layer 20c for sealing.

The outer resin layer 20a serves to protect the battery from the outside, so excellent tensile strength to thickness and weather resistance is required, and generally ONy (stretched nylon) is widely used. The shielding metal layer 20b functions to prevent air and moist from entering the battery, and generally, aluminum (Al) is widely used. The inner resin layer 20c acts to provide sealing with another inner resin layer heat-fused by the heat and pressure applied in a state that the electrode assembly is embedded, and generally, casting polypropylene (CPP) is widely used.

The laminate sheet 20 of a multi-layer structure has a structure in which the inner resin layers 20c face each other in the sealing part, and the inner resin layers 20c are joined with each other by heat fusion. Thus, at an end where the laminate sheet 20 is joined, the inner resin layer 20c is exposed to the outside, and the inner resin layer 20c made mainly of polymer resin is susceptible to water permeation and there is the likelihood that the electrolyte solution leaks, which is a deterioration factor of the life and stability of the battery for a long-term use.

### DISCLOSURE

### Technical Problem

The present disclosure is designed to solve the above problem, and therefore, the present disclosure is to providing a lithium secondary battery in which a water permeation prevention member is attached to a sealing part formed in a pouch case to prevent water permeation from the outside.

### Technical Solution

To achieve the above object, a pouch-type secondary battery according to one aspect of the present disclosure includes an electrode assembly comprising a cathode plate and an anode plate and a separator interposed between the cathode plate and the anode plate, and a pouch-type case formed by receiving and packaging the electrode assembly and an electrolyte solution inside, the pouch-type case having a sealing part formed along a circumference thereof, wherein a water permeation prevention member is attached to the entire sealing part formed along the circumference of the pouch-type case by welding.

The water permeation prevention member may be formed thicker in a thicknesswise direction in which the water permeation prevention member is attached to the end of the sealing part than in a heightwise direction in which the water permeation prevention member is attached to the top and bottom of the sealing part, and the water permeation prevention member may be attached by welding.

A hole may be formed by pressing the sealing part using a molding jig with a plurality of protrusions, and the water permeation prevention member may fill the hole by welding and be attached to the entire sealing part.

The hole may be formed in a quadrangular shape along a lengthwise direction in which an electrode lead is formed.

The water permeation prevention member may include polyethylene terephthalate (PET).

The water permeation prevention member may include any one selected from selected from silicon-based, epoxy-based, cyanoacrylic acid-based, polyvinylacrylate-based, ethylene acetate-based, acrylate-based, polychloroprene-based, a compound-based of polyurethane resin and polyester resin, a compound-based of polyol and polyurethane resin, a compound-based of acrylic polymer and polyurethane resin, polyimide-based, and a compound-based of cyanoacrylate and urethane, or mixtures thereof.

The water permeation prevention member may include any one of epoxy-based resin and silicon-based resin, or mixtures thereof.

### Advantageous Effects

According to one aspect of the present disclosure, a water permeation prevention member is attached to a sealing part of a pouch-type case of a lithium secondary battery, thereby preventing water permeation from the outside and impeding degradation of the battery, resulting in increased life span of the battery.

Also, the water permeation prevention member is formed thicker in a widthwise direction in which the water permeation prevention member is attached to the end of the sealing part than in a heightwise direction in which the water permeation prevention member is attached to the top and bottom of the sealing part, thereby preventing the water permeation more effectively.

According to another aspect of the present disclosure, a hole is formed by pressing the sealing part using a molding jig with a plurality of protrusions and is filled by welding a film, and the film is attached to the sealing part, thereby preventing the water permeation more effectively.

Also, the water permeation prevention member such as the film is attached to the sealing part of the pouch-type case of the lithium secondary battery, thereby ensuring the reliable joining of the sealing part.

### BRIEF DESCRIPTION OF THE DRAWINGS

The accompanying drawings illustrate a preferred embodiment of the present disclosure and together with the foregoing disclosure, serve to provide further understanding of the technical spirit of the present disclosure, and thus, the present disclosure is not construed as being limited to the drawing.

FIG. 1 is an exploded perspective view of a pouch-type secondary battery according to a related art.

FIG. 2 is a diagram illustrating a process of forming a sealing part of a pouch-type case of FIG. 1, as viewed in cross section.

FIG. 3 is a diagram illustrating a construction of a pouch-type secondary battery with a water permeation prevention member attached thereto according to an exemplary embodiment of the present disclosure.

FIG. 4 is a partial cross-sectional view of a sealing part with a water permeation prevention member attached thereto according to an exemplary embodiment of the present disclosure.

FIG. 5 is a partial cross-sectional view of a sealing part with a water permeation prevention member attached thereto according to another exemplary embodiment of the present disclosure.

FIG. 6 is a flowchart illustrating a method for manufacturing a pouch-type secondary battery according to an exemplary embodiment of the present disclosure.

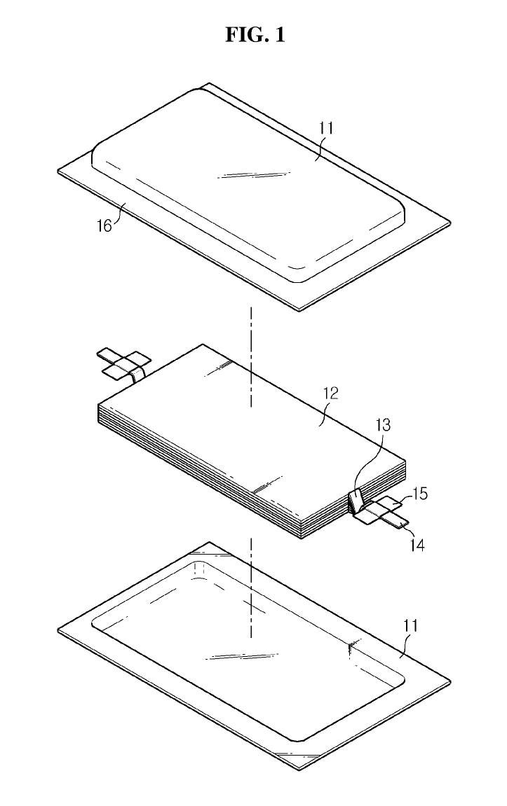

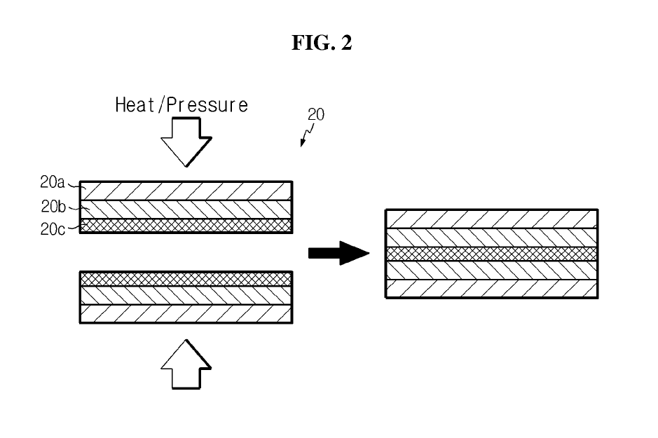

### MODE FOR CARRYING OUT THE INVENTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

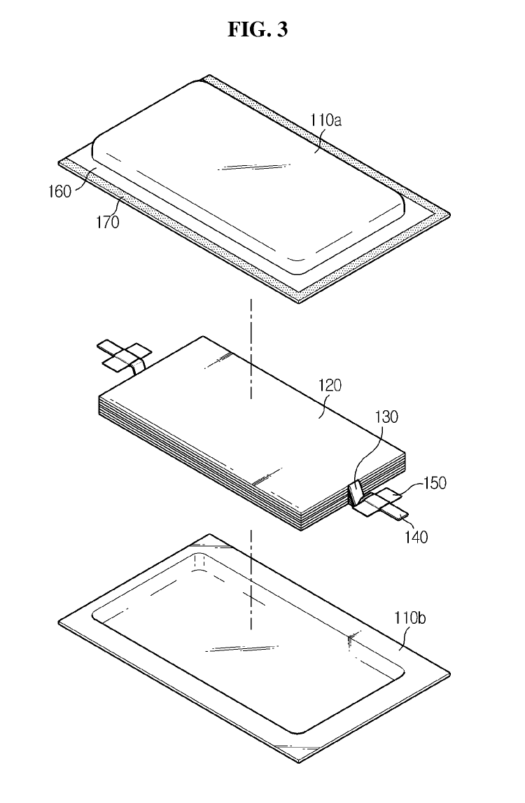

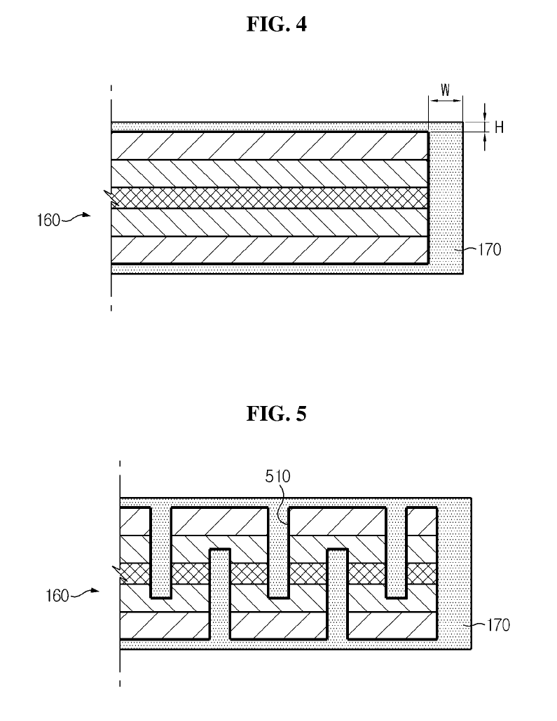

FIG. 3 is a diagram illustrating a construction of the pouch-type secondary battery with the water permeation prevention member attached thereto according to an exemplary embodiment of the present disclosure, and FIG. 4 is a partial cross-sectional view of the sealing part with the water permeation prevention member attached thereto according to an exemplary embodiment of the present disclosure.

Referring to FIGS. 3 and 4, the secondary battery according to the present disclosure includes a case 110a and 110b, an electrode assembly 120, an electrode tab 130, an electrode lead 140, a sealing part 160, and a water permeation prevention member 170 which is attached to the sealing part.

The case includes an upper pouch case 110a and a lower pouch case 11b sealed along a peripheral area by a heat fusion process to receive the electrode assembly inside.

In this instance, the pouch case may be an aluminum laminate sheet. After the electrode assembly 120 is mounted at a location corresponding to a receiving part between the upper pouch case 110a and the lower pouch case 11b, a sealing process is performed by heat-fusing the peripheral area of the pouch case through a heat fusion process. The electrode assembly 120 includes a cathode plate, an anode plate, and a separator. That is, the electrode assembly 120 has the cathode plate and the anode plate stacked in a sequential order with the separator interposed therebetween, and the cathode plate and the anode plate are electrically isolated from each other. The electrode assembly 120 may be formed in various structures, for example, a roll type, a stack type, or a stack/folding type, according to embodiments.

The cathode plate includes a cathode current collector made of a metal thin plate with high conductivity, for example, an aluminum (Al) foil, and a cathode active material layer coated on both surfaces of the cathode current collector. The cathode plate may have an area of the cathode current collector where the cathode active material layer is not formed on the both sides, i.e., a cathode coating-free part. At one end of the cathode coating-free part, the cathode plate may be joined with a cathode tab made of a metal, for example, aluminum (Al).

The anode plate includes an anode current collector made of a conductive metal thin plate, for example, a copper (Cu) foil, and an anode active material layer coated on both surfaces of the anode current collector. The anode plate may have an area of the anode current collector where the anode active material layer is not formed on the both sides, i.e., an anode coating-free part. At one end, the anode plate may be joined with an anode tab made of a metal, for example, nickel (Ni). Similar to the cathode plate, at least two anode plates may be included based on the type of the electrode assembly 120, and particularly, in the case of a stack-type electrode assembly, a plurality of anode plates may be included.

The separator is disposed between the cathode plate and the anode plate to electrically isolate the cathode plate from the anode plate, and may be formed of a porous membrane between the cathode plate and the anode plate to allow lithium ions to pass therethrough. The separator may be made of a porous membrane using, for example, polyethylene (PE) or polypropylene (PP), or a composite film thereof.

The electrode tab 130 extends from the electrode assembly 120. The electrode tab 130 is not directly exposed to the outside of the case 110a and 110b, and may be connected to other component such as the electrode lead 140.

The electrode lead 140 is electrically connected to the electrode tab 130. One end of the electrode lead 140 is connected to the electrode tab 130, and the other end is exposed to the outside of the case 110a and 110b, and the other end exposed to the outside may function as an electrode terminal. Thus, the other end of the electrode lead 140 may be connected to a charger or a load to charge/discharge the secondary battery. Also, an insulation film 150 may be attached to a portion of upper/lower surfaces of the electrode lead 140 to increase sealing with the battery case while ensuring the electrical insulation.

The sealing part 160 may be formed along an outer circumference of the pouch by joining or adhering the upper pouch case 110a and the lower pouch case 110b by, for example, heat fusion, in the sealing process of the pouch-type case. However, when the sealing part 160 is formed through the sealing process but joining is not achieved well, water may come in from the outside through the sealing part 160, and when even a small amount of water permeates the battery, degradation of the battery is accelerated, there is a risk of explosion, and the battery reduces in life span.

Accordingly, as shown in FIG. 4, the present disclosure attaches the water permeation prevention member 170 along the entire circumference of the pouch case with the sealing part 160 to prevent water permeation. In this instance, the water permeation prevention member 170 may be attached to the end of the sealing part 160 and the upper and lower surfaces of the sealing part 160 formed along the circumference of the pouch case by a welding method (for example, ultrasonic welding, laser welding, and the like).

Specifically, because water permeation occurs through a crevice in an inner resin layer where the upper pouch case 110a and the lower pouch case 110b are joined with each other during the heat fusion process by which the sealing part 160 is formed, the water permeation prevention member 170 attached to the sealing part 160 formed along the circumference of the pouch case is thicker in a widthwise direction W in which the water permeation prevention member 170 is attached to the end of the sealing part 160 than in a heightwise direction H in which the water permeation prevention member 170 is attached to the top and bottom of the sealing part 160, and preferably is formed far beyond a distance at which water can permeate from the outside.

In this instance, the water permeation prevention member 170 may be a film of, for example, polyethylene terephthalate (PET), and the polyethylene terephthalate (PET) is saturated polyester obtainable by polycondensation of terephthalic acid and ethylene glycol, and is less influenced by temperature and moisture and has poor water absorbing characteristics. The water permeation prevention member 170 is not limited thereto, and may include any material capable of preventing water permeation. Specifically, the water permeation prevention member 170 may include materials for an adhesive, a sealing agent, and a waterproof agent, for example, any one selected from silicon-based, epoxy-based, cyanoacrylic acid-based, polyvinylacrylate-based, ethylene acetate-based, acrylate-based, polychloroprene-based, a compound-based of polyurethane resin and polyester resin, a compound-based of polyol and polyurethane resin, a compound-based of acrylic polymer and polyurethane resin, polyimide-based, and a compound-based of cyanoacrylate and urethane, or mixtures thereof. Preferably, the water permeation prevention member 170 may include epoxy-based resin and silicon-based resin, singularly or in combination. Also, a structure for preventing the water permeation step by step is illustrated through the embodiment of FIG. 5.

FIG. 5 is a partial cross-sectional view of a sealing part with a water permeation prevention member attached thereto according to another exemplary embodiment, and a hole 510 is formed in the sealing part 160 and is filled with the water permeation prevention member 170. This structure is for preventing the water permeation from occurring through a crevice created by cracking in the water permeation prevention member 170 attached to the end of the sealing part 160.

The hole 510 is formed by pressing the sealing part 160 formed along the circumference of the pouch case using a molding jig with a plurality of protrusions. In this instance, the hole 510 is preferably elongated in the lengthwise direction in which the electrode lead is formed. In this instance, although the exemplary embodiment of the present disclosure describes that the hole 510 is formed in a quadrangular shape to serve as a shield membrane, the present disclosure is not limited thereto, and may employ any shape enabling water permeation prevention from the outside.

Subsequently, the water permeation prevention member 170 is filled in the hole 510 through welding, and the water permeation prevention member 170 is attached to the entire sealing part 160 formed along the circumference of the pouch case through welding, therefore, even if water permeates through a crevice created by cracking in the water permeation prevention member 170 attached to the end of the sealing part 160, water is shut off step by step by the water permeation prevention member filled in the hole 510, thereby preventing the water permeation from the outside more effectively.

Also, by attaching the water permeation prevention member such as a film to the sealing part of the pouch-type case of the lithium secondary battery, reliable joining of the sealing part may be ensured.

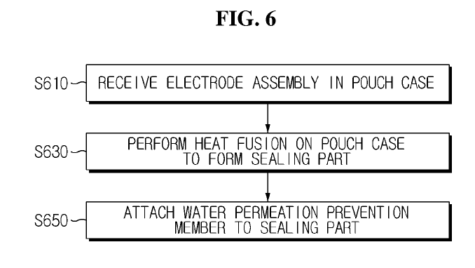

FIG. 6 is a flowchart illustrating a method for manufacturing the pouch-type secondary battery according to an exemplary embodiment of the present disclosure. Referring to FIG. 6, to manufacture the pouch-type secondary battery according to an exemplary embodiment of the present disclosure, first, the pouch case including the upper pouch case 110a and the lower pouch case 110b and the electrode assembly 120 including the cathode plate and the anode plate with the separator interposed between the cathode plate and the anode plate are prepared.

Subsequently, the electrode assembly 120 is received in the pouch case, and heat fusion is performed on the upper pouch case 110a and the lower pouch case 110b to form the sealing part 160 (S610)(S630).

The water permeation prevention member 170 is attached to the end of the sealing part 160 and the upper and lower surfaces of the sealing part 160 formed along the circumference of the pouch case. In this instance, the water permeation prevention member 170 may be attached to the sealing part 160 by a welding method (for example, ultrasonic welding, laser welding, and the like) (S650).

Specifically, because water permeation occurs through a crevice in an inner resin layer where the upper pouch case 110a and the lower pouch case 110b are joined with each other during the heat fusion process by which the sealing part 160 is formed, the water permeation prevention member 170 attached to the sealing part 160 formed along the circumference of the pouch case is thicker in the widthwise direction W in which the water permeation prevention member 170 is attached to the end of the sealing part 160 than in the heightwise direction H in which the water permeation prevention member 170 is attached to the top and bottom of the sealing part 160, and preferably is formed with a greater thickness than a distance at which water can permeate from the outside.

In this instance, the water permeation prevention member 170 may be a film of, for example, polyethylene terephthalate (PET), and the polyethylene terephthalate (PET) is saturated polyester obtainable by polycondensation of terephthalic acid and ethylene glycol, and is less influenced by temperature and moisture and has poor water absorbing characteristics. The water permeation prevention member 170 is not limited thereto, and may include any material capable of preventing water permeation. Specifically, the water permeation prevention member 170 may include materials for an adhesive, a sealing agent, and a waterproof agent, for example, any one selected from silicon-based, epoxy-based, cyanoacrylic acid-based, polyvinylacrylate-based, ethylene acetate-based, acrylate-based, polychloroprene-based, a compound-based of polyurethane resin and polyester resin, a compound-based of polyol and polyurethane resin, a compound-based of acrylic polymer and polyurethane resin, polyimide-based, and a compound-based of cyanoacrylate and urethane, or mixtures thereof. Preferably, the water permeation prevention member 170 may include epoxy-based resin and silicon-based resin, singularly or in combination.

Also, even if water permeates, to shut off the water step by step, a hole may be formed before the water permeation prevention member 170 is attached to the sealing part 160.

That is, after the sealing part 160 is formed by heat fusion and the hole 510 is formed in the sealing part 160, the hole 510 formed in the sealing part 160 is filled with the water permeation prevention member 170 to prevent the water permeation from the outside more effectively.

For example, the hole 510 is formed by pressing the sealing part 160 formed along the circumference of the pouch case using a molding jig with a plurality of protrusions, and the hole 510 is preferably elongated in the lengthwise direction in which the electrode lead is formed. In this instance, although the exemplary embodiment of the present disclosure describes that the hole 510 is formed in a quadrangular shape to serve as a shield membrane, the present disclosure is not limited thereto, and may employ any shape enabling water permeation prevention from the outside.

Subsequently, the water permeation prevention member 170 is filled in the hole 510 through welding, and the water permeation prevention member 170 is attached to the entire sealing part 160 formed along the circumference of the pouch case through welding, therefore, even if water permeates through a crevice created by cracking in the water permeation prevention member 170 attached to the end of the sealing part 160, water is shut off step by step by the water permeation prevention member filled in the hole 510, thereby preventing the water permeation from the outside more effectively

While the present disclosure has been described in connection with a limited number of embodiments and drawings, the present disclosure is not limited thereto, and it should be understood that various changes and modifications may be made by those skilled in the art within the spirit and scope of the present disclosure and equivalents to the appended claims.

What is claimed is:

1. A pouch-type secondary battery comprising:
an electrode assembly comprising a cathode plate and an anode plate and a separator interposed between the cathode plate and the anode plate; and
a pouch-type case formed by receiving and packaging the electrode assembly and an electrolyte solution inside, the pouch-type case having a sealing part formed along a circumference thereof,
wherein a water permeation prevention member is attached to the entire sealing part formed along the circumference of the pouch-type case by welding.

2. The pouch-type secondary battery according to claim 1, wherein the water permeation prevention member is formed thicker in a thicknesswise direction in which the water permeation prevention member is attached to the end of the sealing part than in a heightwise direction in which the water permeation prevention member is attached to the top and bottom of the sealing part, and the water permeation prevention member is attached by welding.

3. The pouch-type secondary battery according to claim 1, wherein a hole is formed by pressing the sealing part using a molding jig with a plurality of protrusions, and the water permeation prevention member fills the hole by welding and is attached to the entire sealing part.

4. The pouch-type secondary battery according to claim 3, wherein the hole is formed in a quadrangular shape along a lengthwise direction in which an electrode lead is formed.

5. The pouch-type secondary battery according to claim 1, wherein the water permeation prevention member includes polyethylene terephthalate (PET).

6. The pouch-type secondary battery according to claim 1, wherein the water permeation prevention member includes any one selected from selected from silicon-based, epoxy-based, cyanoacrylic acid-based, polyvinylacrylate-based, ethylene acetate-based, acrylate-based, polychloroprene-based, a compound-based of polyurethane resin and polyester resin, a compound-based of polyol and polyurethane resin, a compound-based of acrylic polymer and polyurethane resin, polyimide-based, and a compound-based of cyanoacrylate and urethane, or mixtures thereof.

7. The pouch-type secondary battery according to claim 1, wherein the water permeation prevention member includes any one of epoxy-based resin and silicon-based resin, or mixtures thereof.
